(19) United States
(12) Patent Application Publication
(10) Pub. No.: US 2009/0047476 A1
(43) Pub. Date: Feb. 19, 2009

(54) ARTIFICIAL LEATHER AND METHOD FOR PRODUCING THE SAME

(75) Inventors: Masasi Meguro, Okayama (JP); Yasuhiro Yoshida, Okayama (JP); Hisao Yoneda, Okayama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KURARAY CO., LTD., Okayama (JP)

(21) Appl. No.: 12/281,026

(22) PCT Filed: Feb. 27, 2007
(86) PCT No.: PCT/JP2007/053634

§ 371 Date: Oct. 16, 2008

(30) Foreign Application Priority Data
Feb. 28, 2006 (JP) 2006-052404
Mar. 29, 2006 (JP) 2006-090917

(51) Int. Cl. D06N 3/00; B05D 3/06; B05D 3/02

(52) U.S. Cl. 428/151; 427/557; 427/385.5; 428/904

(57) ABSTRACT

An artificial leather including an entangled body made of bundles of microfine fibers and an elastic polymer impregnated into the entangled body. A part of the elastic polymer penetrates into the bundles of microfine fibers. The degree of penetration of the elastic polymer is from 1 to 30% by area when measured on a cross section which is taken along a direction perpendicular to a lengthwise direction of the bundles of microfine fibers. The fiber-holding property is improved by the elastic polymer which partly penetrates into the bundles of microfine fibers, and therefore, the artificial leather has a good hand without deteriorating the surface quality.

### TECHNICAL FIELD

The present invention relates to an artificial leather and a production method thereof.

### BACKGROUND ART

A high performance leather-like sheet is hitherto produced by impregnating a solution or dispersion of an elastic polymer such as polyurethane into a fiber-entangled body such as a nonwoven fabric and a woven or knitted fabric or into a sheet material obtained by processing the fiber-entangled body. This method has been well known in the art and widely used in industrial production.

For example, a soft leather-like sheet is produced by impregnating polyurethane into a fibrous substrate made of sea-island microfine fiber-forming fibers, coagulating the polyurethane, and then, removing the sea component from microfine fiber-forming fibers by extraction (for example, Patent Document 1). It has been disclosed that by using mix spun fibers containing a sea component polymer easily extractable with a solvent, the adhesion between microfine fibers after extraction is reduced and microfine fibers which are easily opened are obtained (for example, Patent Document 2). In the leather-like sheet proposed above, the elastic polymer is present around bundles of microfine fibers with voids therebetween. Therefore, the hand is soft, but the fibers are not held sufficiently because the elastic polymer is not in direct contact with the fibers.

In a known technique, the sea component is removed from sea-island microfine fiber-forming fibers by extraction, and then, an elastic polymer is impregnated into the obtained fibrous substrate. In this technique, the fibers are well held because of the direct contact of the elastic polymer with fibers. However, the direct contact made the hand hard. To remove this problem, there have been proposed a method in which polyvinyl alcohol is impregnated before the removal of the sea component by extraction, thereby controlling the amount of the elastic polymer to be brought into direct contact with fibers and a method in which polyvinyl alcohol is impregnated twice to compensate the deficiency thereof at the central portion of fabric which is caused by its migration (for example, Patent Document 3). However, it is difficult to control the amount of the elastic polymer so as to directly hold the bundles of fibers or so as to hold the microfine fibers uniformly along the thickness direction.

Recently, in view of avoiding the adverse influence of organic solvents on human body and environment, it has been desired to develop a solvent-free production method of artificial leather. For example, the use of microfine fiber-forming fibers which can be converted to microfine fibers by extracting a polymer component with water and the impregnation of an aqueous dispersion of elastic polymer into a fiber-entangled body are considered. However, as compared with a solution or dispersion of elastic polymer in an organic solvent, an aqueous dispersion of elastic polymer is generally difficult to form a continuous elastic polymer layer to likely cause a poor fiber-holding ability. If the amount of an aqueous dispersion of elastic polymer to be impregnated is increased to form a continuous layer, the resultant artificial leather is hardened to have a poor hand. To remove this problem, there has been proposed a method in which a fiber-entangled body is impregnated with an elastic polymer, microfine fiber-forming fibers are converted to microfine fibers, and then, the fiber-entangled body is further impregnated with an additional aqueous dispersion of elastic polymer so as to directly hold the microfine fibers by the additional elastic polymer (for example, Patent Document 4). In the proposed method, however, the elastic polymer migrates and may hold the fibers more excessively than expected, to likely deteriorate the hand of a resultant artificial leather.

Therefore, an artificial leather which is fully sufficient in both the fiber-holding ability and hand has not yet been obtained by a method using an aqueous dispersion of elastic polymer.

[Patent Document 1] JP 41-9315B (pages 1-3)
[Patent Document 2] JP 5-59615A (pages 1-3)
[Patent Document 3] JP 49-10633B (pages 1-3)
[Patent Document 4] JP 2003-306878A (pages 1-4)

### DISCLOSURE OF THE INVENTION

The present invention has been made to provide an artificial leather produced by using an aqueous dispersion of elastic polymer, which is fully sufficient in both the fiber-holding ability and hand and to provide a production method thereof.

Thus, the present invention relates to an artificial leather which comprises an entangled body made of bundles of microfine fibers and an elastic polymer impregnated into the entangled body, wherein a part of the elastic polymer penetrates into the bundles of microfine fibers and a degree of penetration of the elastic polymer is from 1 to 30% by area when measured on a cross section which is taken along a direction perpendicular to a lengthwise direction of the bundles of microfine fibers.

The present invention further relates to a suede-finished artificial leather produced from the above artificial leather.

The present invention still further relates to a method of producing an artificial leather, which comprises:

(1) a step of impregnating an aqueous dispersion of elastic polymer into a fiber-entangled body which is formed from composite fibers comprising a water-soluble polymer component and a sparingly water-soluble polymer component;
(2) a step of raising a temperature of a surface of the fiber-entangled body impregnated with the aqueous dispersion of elastic polymer by an infrared irradiation to a temperature which is 10° C. or more higher than a gelation temperature of the aqueous dispersion of elastic polymer;
(3) a step of reducing a water content of the fiber-entangled body to 50% by mass or less while keeping the surface of the fiber-entangled body at a temperature which is 10° C. or more higher than the gelation temperature of the aqueous dispersion of elastic polymer;
(4) a step of removing water remaining in the fiber-entangled body by drying, thereby fixing the elastic polymer to the fiber-entangled body; and
(5) a step of converting the composite fibers to bundles of microfine fibers by extracting the water-soluble polymer component with a hot water from the composite fibers in the fiber-entangled body having the elastic polymer fixed.

### BEST MODE FOR CARRYING OUT THE INVENTION

The present invention will be explained below in more detail.

The bundles of microfine fibers for forming the artificial leather of the invention are not particularly limited and suitably selected according to the use of the artificial leather. Preferred are bundles of microfine fibers formed from microfine fiber-forming fibers. In view of improving the hand of the resultant artificial leather and the surface appearance of the resultant suede-finished artificial leather, the single fiber fineness of each microfine fiber is preferably from 0.0001 to 0.5 dtex, more preferably from 0.001 to 0.45 dtex, and particularly preferably from 0.002 to 0.4 dtex because the color development is good and the microfine fibers are held well by the elastic polymer. The fineness of each bundle of microfine fibers is preferably from 2 to 10 dtex and more preferably from 3 to 8 dtex. Each bundle preferably contains 10 to 100 microfine fibers.

It is important that the microfine fiber-forming fibers are composed of a water-soluble polymer component and a sparingly water-soluble polymer component. Having such polymer components, it is possible to form the microfine fibers without using an organic solvent, to reduce the load on the environment. In addition, by combinedly using an aqueous dispersion of elastic polymer, the specific penetration structure of the elastic polymer into the bundles of microfine fibers, which will be described below, is obtained. In the present invention, the term “water-soluble” means that the polymer dissolves in 100 g of water at 60° C. by 10 g or more, and the term “sparingly water-soluble” means that the polymer dissolves in 100 g of water at 60° C. up to 0.1 g.

The microfine fiber-forming fiber may be any of sea-island fibers such as sea-island composite spun fibers and sea-island mix spun fibers, and multi-component composite fibers such as radially layered fibers and multi-layered fibers as long as the fibers are formed from at least one kind of the water-soluble polymer component and at least one kind of the sparingly water-soluble polymer component which is converted to microfine fibers. It is important that the component to be extracted is a spinnable water-soluble polymer. The water-soluble polymer component may be a known polymer which is extractable with water or an aqueous solution (hereinafter also referred to as “aqueous solvent”), and preferably a polyvinyl alcohol copolymer (PVA) which is soluble in the aqueous solvent. Since PVA is easily removed by the extraction with hot water, the extracting treatment is substantially free from the decomposition of the microfine fiber-forming component and the elastic polymer. Therefore, the thermoplastic resin for the component of microfine fibers and the elastic polymer are not limited to specific kinds and the load on the environment is small.

PVA may be homo PVA or modified PVA introduced with co-monomer units, with the modified PVA being preferred in view of a good melt spinnability, water solubility, fiber properties and shrinkability in the extracting treatment. Preferred examples of the co-monomer unit are at least one unit derived from α-olefins having 4 or less carbon atoms such as ethylene, propylene, 1-butene and isobutene; and alkyl vinyl ethers such as methyl vinyl ether, ethyl vinyl ether, n-propyl vinyl ether, isopropyl vinyl ether and n-butyl vinyl ether. The content of the comonomer units in PVA is preferably from 1 to 20 mol %. A modified PVA containing ethylene units in an amount of 4 to 15 mol % is more preferred, because the fiber properties are enhanced.

The saponification degree of PVA is preferably 90 to 99.99 mol %, more preferably 92 to 99.98 mol %, still more preferably 94 to 99.96 mol %, and particularly preferably 96 to 99.95 mol %. If being 90 mol % or more, the heat stability of PVA is good and the composite melt spinning is performed without causing thermal decomposition and gelation. PVA having a saponification degree exceeding 99.99 mol % is difficult to produce stably.

The sparingly water-soluble polymer component is not particularly limited as long as it is selected from known resins capable of forming microfine fibers, for example, such as polyamides, polyesters and polyolefins. Preferred are polyesters such as polyethylene terephthalate, polybutylene terephthalate, polyethylene terephthalate copolymerized with isophthalic acid and polybutylene terephthalate copolymerized with isophthalic acid; and polyamides such as nylon 6, nylon 11 and nylon 12. If the water-soluble polymer such as PVA is spun at high temperatures, the spinnability may be reduced. Therefore, in view of the spinning stability of the microfine fiber-forming fibers, preferred is a sparingly water-soluble polymer component having a melt point of from the melting point of water-soluble polymer component to the melting point of water-soluble polymer component +60° C. In view of the spinnability, the melting point of the water-soluble polymer component is preferably from 160 to 230° C.

The ratio of the water-soluble polymer component and the sparingly water-soluble polymer component each forming the microfine fiber-forming fibers is preferably from 10/90 to 60/40 by mass. Within the above range, the water-soluble polymer component and the sparingly water-soluble polymer component are well dispersed when observing the cross section of the microfine fiber-forming fibers. Therefore, the microfine fiber-forming fibers are converted to uniform microfine fibers and bundles of microfine fibers, thereby giving an artificial leather having a good hand and a suede-finished artificial leather having a uniform raised surface.

The microfine fibers may be included with a pigment. To uniformly disperse the pigment in the microfine fibers, the pigment is preferably added in a master batch manner in which the pigment is kneaded with the sparingly water-soluble polymer component in a compounding machine such as an extruder and then pelletized. The sparingly water-soluble polymer component may be further included, as long as the object and effect of the present invention are not adversely affected, with a stabilizer such as a copper compound, a colorant, a UV absorber, a light stabilizer, an antioxidant, an antistatic agent, a fire retarder, a plasticizer, a lubricant, or a crystallization retarder during the polymerization for its production and a subsequent step. In addition, an inert fine particle of silica, alumina, titanium oxide, calcium carbonate and barium sulfate may be added. These additives may be used alone or in combination of two or more. By such addition, the spinnability and drawability may be improved in some cases.

The microfine fiber-forming fibers are generally drawn by 1.5 to 4 times. The drawing may be performed before or after winding up the fibers extruded from spinning nozzles. The drawing is preferably performed at 50 to 110° C. under heating by a hot air, a hot plate, a hot roller or a water bath, with the drawing under heating by a hot air being preferred because the water content of the water-soluble polymer component is little changed.

The microfine fiber-forming fibers are made into a long-fiber web by a spun-bonding method. Alternatively, the microfine fiber-forming fibers are made into a short-fiber web, for example, by cutting the microfine fiber-forming fibers to staples after crimping, and then, making the staples into a web using a carding machine, a crosslapper or a random webber. The long-fiber web or the short-fiber web is then made into a fiber-entangled body by needle punching. The needle punching may be performed after superposing a woven or knitted fabric on the surface or back surface of the web or interposing a woven or knitted fabric between the webs, if necessary. The needle punching is performed so as to allow the barbs of needles to pass through the web in a needle-punching density of preferably from 400 to 5000 punch/cm² and more preferably from 1000 to 2000 punch/cm².

To unite the woven or knitted fabric, if used, with the web, the number of twist of yarns constituting the woven or knitted fabric is preferably from 10 to 650 T/m and more preferably from 15 to 500 T/m. If being 10 T/m or more, the single yarn of the woven or knitted fabric are entangled with the microfine fiber-forming fibers without coming apart. Therefore, the deterioration of appearance due to damaged yarns heavily exposed to the surface of the fiber-entangled body is prevented. If being 650 T/m or less, the yarns are firmly entangled with the microfine fiber-forming fibers, to unite the web with the woven or knitted fabric. The mass per unit area of the woven or knitted fabric depends upon its final use, and preferably from 20 to 200 g/m² and more preferably from 30 to 150 g/m². If being 20 g/m² or more, the shape retention of the woven or knitted fabric is good and the shifting of fibers is not caused. If being 200 g/m² or less, the space between the yarns of the woven or knitted fabric is moderate to allow the microfine fiber-forming fibers to sufficiently pass through the woven or knitted fabric. Therefore, the web and the woven or knitted fabric are fully entangled to form a united web/woven or knitted fabric body. The kind of the woven or knitted fabric is not particularly limited, and various knitted fabrics having a knitted structure such as warp knitting, weft knitting such as tricot knitting, lace knitting and a combination thereof, and various woven fabrics having a woven structure such as plain weaving, twill weaving, satin weaving and a combination thereof are usable. The woven or knitted structure and density are selected according to the end use.

When the fiber-entangled body impregnated with a solution of elastic polymer is dried by raising the temperature, the fiber-entangled body may shrink largely in some cases. With such shrinking, the space in the fiber-entangled body is reduced to force the impregnated elastic polymer to move toward the surface layer, thereby failing to obtain a uniform distribution of the elastic polymer. To avoid this problem, the fiber-entangled body after needle punching is preferably heat-shrunk before the impregnation of a solution of elastic polymer. The heat shrinking is preferably performed to increase the fiber density of the fiber-entangled body and obtain a suede-finished artificial leather having a dense raised appearance and a good hand. To improve the smoothness of the surface of artificial leather, a heat press may be employed after the heat shrinking, if necessary.

The mass per unit area of the fiber-entangled body is suitably selected according to the use of the artificial leather and not particularly limited, and preferably from 300 to 1500 g/m². The apparent density is preferably from 0.20 to 0.80 g/cm³ and more preferably from 0.25 to 0.70 g/cm³. If being 0.20 g/cm³ or more, the raised appearance and mechanical properties of the suede-finished artificial leather are good. If being 0.80 g/cm³ or less, the hand is prevented from being hard. The thickness of the fiber-entangled body is not particularly limited as long as the mass per unit area and the density are within the above ranges.

The elastic polymer to be impregnated into the fiber-entangled body may be selected from those known in the artificial leather art. For example, various polyurethanes are usable, which are produced by a single-stage or multi-stage reaction of at least one kind of polymer polyol having an average molecular weight of 500 to 3000, at least one kind of polyisocyanate and at least one kind of low molecular compound having two or more active hydrogen atoms. The polymer polyol may be selected from polyester diol, polyether diol, polyether ester diol and polycarbonate diol. The polyisocyanate may be selected from aromatic, alicyclic or aliphatic diisocyanate such as 4,4′-diphenylmethane diisocyanate, isophorone diisocyanate, and hexamethylene diisocyanate. The low molecular compound having two or more active hydrogen atoms may be selected from ethylene glycol and ethylenediamine. A mixture of different kinds of polyurethanes may be impregnated, or different kinds of polyurethanes may be impregnated in several portions. An elastic polymer composition containing, if necessary, another elastic polymer such as synthetic rubber, polyester elastomer and acrylic resin in addition to polyurethane may be used.

Since a water-soluble polymer such as PVA mentioned above is used as one of the components of the microfine fiber-forming fibers, it is important to impregnate the elastic polymer in the form of aqueous dispersion. During the coagulation of the elastic polymer impregnated into the fiber-entangled body in the form of an aqueous dispersion by gelation and during the drying of the coagulated elastic polymer, a certain amount of the water-soluble polymer component constituting the microfine fiber-forming fibers dissolves in the water of the aqueous dispersion, thereby allowing the elastic polymer to penetrate into the microfine fiber-forming fibers from the outer surface thereof. Thus, by converting the microfine fiber-forming fibers to microfine fibers in a later step, bundles of microfine fibers containing the coagulated elastic polymer which is fixed to a limited region inside thereof are obtained.

The aqueous dispersion of the elastic polymer is impregnated into the fiber-entangled body by a known method such as a dip-nip method. However, in some cases, the water-soluble polymer component in the composite fibers is squeezed out by the nipping pressure to contaminate the aqueous dispersion of elastic polymer. Therefore, in the present invention, an impregnating method, for example, a method using a lip coater is preferably used in place of the dip-nip method, because such an impregnating method utilizes the penetrating property of the aqueous dispersion of elastic polymer into the water-soluble polymer component and allows a predetermined amount of the aqueous dispersion of elastic polymer to impregnate only by controlling its supplied amount and concentration without needing a large pressure.

In view of combining the fiber-holding ability by the elastic polymer and a soft hand, the coagulated elastic polymer fixed to the inside of the fiber-entangled body is preferably in substantially discontinued form. To ensure this, the aqueous dispersion of elastic polymer is impregnated preferably in an amount such that the ratio of elastic polymer:fiber-entangled body is 5:95 to 60:40 by mass. The elastic polymer acts as a binder for fibers in the artificial leather. If the ratio of the elastic polymer is within the above range, a sufficient binding effect is obtained, the properties such as tear strength and tensile strength are good and the hand is soft. The concentration of the elastic polymer in the aqueous dispersion is preferably from 5 to 40% by mass.

In the present invention, after impregnating the aqueous dispersion of elastic polymer into the fiber-entangled body, the migration thereof is prevented so as to finally form a penetration structure in which a part of the elastic polymer penetrates into the bundles of microfine fibers from the outer surface thereof in an areal ratio of from 1 to 30% when observed on a cross section of the bundles. With such a penetration structure, the fiber-holding ability of the elastic polymer is improved while keeping a good hand. To obtain such a structure, it is necessary to allow the aqueous dispersion of elastic polymer to rapidly gel before completely evaporating the water while allowing a part of the water-soluble polymer component of the microfine fiber-forming fibers to dissolve in the water. Therefore, in the present invention, the infrared irradiation is employed to rapidly heating the fiber-entangled body impregnated with the aqueous dispersion of elastic polymer, and simultaneously, to dissolve a part of the water-soluble polymer component. Infrared rays having the maximum energy wavelength of 2 to 6 μm are preferably used because the surface and inside of the fiber-entangled body are easily heated, the aqueous dispersion of elastic polymer is quite easily heated because water absorbs infrared ray of 2.6 μm wavelength, and the infrared rays absorbed by and transmitted through the fiber-entangled body impregnated with the aqueous dispersion of elastic polymer are well balanced. The surface of the fiber-entangled body is raised to a temperature 10° C. or more higher than the gelation temperature of the aqueous dispersion of elastic polymer by the infrared irradiation, to reduce the water content of the fiber-entangled body to 50% by mass or less. Thereafter, the remaining water is removed by drying preferably at 130 to 160° C. to fix the elastic polymer.

The surface of the fiber-entangled body is preferably heated to a temperature 10° C. or more higher than the gelation temperature of the aqueous dispersion of elastic polymer and more preferably to a temperature from the gelation temperature +10° C. to the gelation temperature +50° C. within one minute. If the surface temperature of the fiber-entangled body is within the above range, the inside of the fiber-entangled body reaches a temperature equal to or higher than the gelation temperature of the aqueous dispersion of elastic polymer, to promote the heat-sensitive gelation of the elastic polymer. It is preferred to heat the surface of the fiber-entangled body to a temperature within the above range within one minute, because the heat-sensitive gelation easily occurs before the aqueous dispersion of elastic polymer begins to migrate. During the temperature rise by the infrared irradiation, a part of the water-soluble polymer component dissolves in the water in the aqueous dispersion of elastic polymer to allow the sparingly water-soluble polymer component to be moderately exposed. Since the elastic polymer comes into direct contact with the exposed sparingly water-soluble polymer component, the penetration structure in which a part of the elastic polymer penetrates into the bundles of microfine fibers from the outer surface thereof in an areal ratio of 1 to 30% is easily obtained nearly throughout the artificial leather obtained after the treatment of conversion to microfine fibers.

After raising the surface temperature of the fiber-entangled body by infrared irradiation, the surface is kept at a temperature within the above range for 0.3 to 1.5 min, during which the water content of the fiber-entangled body is reduced to 50% by mass or less. If the content is higher than 50% by mass, the water-soluble polymer component dissolves in a larger amount than needed in the subsequent heat-drying step, to unfavorably increase the amount of the elastic polymer which is brought into direct contact with the sparingly water-soluble polymer component. In addition, the migration comes to easily occur. As a result, the elastic polymer penetrates into the bundles of fibers in an amount exceeding 30% by area, to make the hand of the artificial leather hard. The lower limit of the water content is not critical and preferably 10% or more in view of drying efficiency. To uniformly heat both the surfaces of the fiber-entangled body, the infrared irradiation is preferably conducted from both the surfaces under the same conditions. To evaporate the water evenly from both the surfaces, the infrared irradiation is preferably conducted while holding the fiber-entangled body vertically.

The water content is determined by the following formula:

Water content (%)=(I−J)/J×100

wherein I is the mass per unit area (g/m²) of the fiber-entangled body after the impregnation with the aqueous dispersion of elastic polymer and the infrared irradiation, and J is the mass per unit area (g/m²) of the fiber-entangled body after the impregnation with the aqueous dispersion of elastic polymer and the coagulation by drying.

After the infrared irradiation, the fiber-entangled body is heated for drying at 110 to 170° C. for 1 to 10 min, to evaporate the water remaining therein and allow the fixed elastic polymer to fix more firmly. If the heat drying is omitted, the elastic polymer swells and falls off when treated with a hot water in the microfine fiber-forming treatment by the extraction of the water-soluble polymer component or the dyeing treatment. Therefore, the fibers in the surface layer are not sufficiently held by the elastic polymer, to deteriorate the appearance of the resultant suede-finished artificial leather. The heat drying is performed by a known method such as a hot-air dying and a moist heat drying. The heat drying temperature and time are selected according to the degree of fixing ability of the elastic polymer, and preferably 110 to 160° C. for 1 to 9 min.

Then, the water-soluble polymer component is extracted for removal by a treating liquid which is a non-solvent for the sparingly water-soluble polymer component and the elastic polymer but a good solvent for the water-soluble polymer component (component to be removed by extraction), for example, water and an acidic or alkaline aqueous solution. By this treatment, the microfine fiber-forming fibers are converted to the bundles of microfine fibers, to obtain the artificial leather. The hot water extraction is preferably employed because of its low load on the environment. The temperature of the hot water is preferably from 60 to 100° C. and more preferably from 80 to 95° C. If being 60° C. or more, the extraction time is shorted, therefore, a higher temperature of the hot water is preferred. If being 100° C. or less, since the fixing of the impregnated elastic polymer to the microfine hardly become loose, the fiber-holding ability of the elastic polymer is kept.

The bundles of microfine fibers of the obtained artificial leather include the elastic polymer penetrated. The amount of the penetrated elastic polymer is 1 to 30% by area when determined on the cross section taken along the direction perpendicular to the lengthwise direction of the bundles of microfine fibers. With such a penetration structure, an artificial leather such as a suede-finished artificial leather is obtained, which has a soft hand and little causes deterioration of quality due to fall-off of raised fibers because the microfine fibers are firmly held by the elastic polymer. The areal ratio of the penetrated elastic polymer is preferably from 1.5 to 25% and more preferably from 2 to 20%. Within the above range, the bundles of microfine fibers are held by the elastic polymer more firmly, to provide a suede-finished artificial leather with a good appearance which is free from the pull-out of microfine fibers on its surface and has fibrillated microfine fibers on its surface. Particularly, it is preferred that the elastic polymer is not present in the central portion (a portion deeper than 20% of the center-to-surface distance from the surface) of the bundles of microfine fibers.

If the area ratio is less than 1%, the hand of the resultant artificial leather is soft because the amount of the penetrated elastic polymer in the bundles of microfine fibers which is in direct contact with the microfine fibers is small. However, the dense feeling (stiffness) is likely to be poor. In addition, the fiber pull-out easily occurs to deteriorate the appearance of the suede-finished artificial leather, because the amount of the microfine fibers held by the elastic polymer is small. If exceeding 30%, the fiber pull-out is prevented and the appearance is improved. However, the hand becomes hard because of an excessively large amount of the elastic polymer which is in direct contact with the microfine fibers. In view of keeping the hand good, the penetrated elastic polymer is preferably not continuous but discontinuous along the lengthwise direction of the bundles of microfine fibers. On a cross section taken along the direction perpendicular to the lengthwise direction of the bundles of microfine fibers, the penetrated elastic polymer is either discontinuous or partly continuous.

The above areal ratio, i.e., the degree of penetration A (%) of the elastic polymer into the bundles of microfine fibers is calculated from the following equation:

A=B/C×100

wherein B is the area of the elastic polymer on a cross section taken along the direction perpendicular to the lengthwise direction of the bundles of microfine fibers and C is the area of the cross section.

The areas B and C are determined from an electron micrograph of the cross section taken along the direction perpendicular to the lengthwise direction of the bundles of microfine fibers. The cross section is defined by the closed curve which successively connects the centers of microfine fibers positioned in the periphery of the bundles of microfine fibers.

The penetrated elastic polymer is preferably present discontinuously in a depth of 0.2 to 7 μm from the periphery of the bundles of microfine fibers in average. With the bundles of microfine fibers having such a structure, a suede-finished artificial leather free from the fall-off of raised fibers and having raised fibers with a uniform length is obtained. The term “discontinuous” used herein is a dotted configuration of the elastic polymer particularly obtained when impregnated in the form of a aqueous dispersion, distinguishing from a continuous configuration to be obtained when impregnated in the form of a solution in an organic solvent.

It is preferred for the suede-finished artificial leather that the microfine fibers in the bundles in the vicinity of the interface between the raised portion and the artificial leather are also partly fixed by the elastic polymer. If being partly fixed, the pull-out of the microfine fibers which form the raised fibers is prevented, to obtain a suede-finished artificial leather having a good surface property. Since a part of the elastic polymer penetrates into the bundles of microfine fibers in the artificial leather in an areal ratio of 1 to 30%, the artificial leather combines a sufficient fiber-holding property and a good hand. However, since the raised portion may be subject to a large force such as friction force, the fibers constituting the raised fibers come to be easily pulled out in some cases. If a part of the microfine fibers which form the bundles in the vicinity of the interface between the raised portion and the artificial leather is fixed by the elastic polymer, the pull-out of the raised fibers are prevented synergistically with the effect of holding the microfine fibers inside the artificial leather, thereby remarkably improving the surface properties.

The vicinity of the interface between the raised portion and the artificial leather is the foot portions of the microfine fibers which form the raised fibers of the suede-finished artificial leather. Particularly, it means the region in which the solution or dispersion of the elastic polymer is present after the solution or dispersion is provided to the raised surface of the suede-finished artificial leather or the surface of the artificial leather before raised. More particularly, it means the region from a depth of 100 μm of the artificial leather to a height of 100 μm above the foot portion (surface of the artificial leather) of the bundles of microfine fibers which form the raised portion.

The elastic polymer is provided to the raised surface of the suede-finished artificial leather or the surface of the artificial leather before raising the surface preferably in the form of an aqueous dispersion, because the load on the environment is small. In addition, the water-dispersed elastic polymer fixes discontinuously, to make it easy to loosen the microfine fibers gathered by the raising treatment, thereby facilitating the fibrillation (loosening the gathered microfine fibers) in a later stage. The provided elastic polymer is then heat-dried (preferably at 130 to 160° C. for 2 to 10 min) to allow the elastic polymer to firmly fix to the microfine fibers in the vicinity of the interface. In view of adhesion and surface properties, the elastic polymer for such treatment is preferably the same as or similar to the elastic polymer which have been impregnated into the artificial leather, Known elastic polymers may be used as long as the effect of the present invention is not adversely affected. The elastic polymer may be included with penetrant, antifoaming agent, thickening agent, bulking agent, curing promotor, antioxidant, ultraviolet absorber, fluorescent agent, fungicidal agent, water-soluble polymer such as polyvinyl alcohol and carboxymethylcellulose, dye or pigment. The concentration of the elastic polymer in the aqueous dispersion is preferably from 5 to 40% by mass.

The aqueous dispersion of elastic polymer is provided to the surface of the artificial leather at any stage after the conversion to the microfine fibers, for example, immediately after the conversion to the microfine fibers, after the raising treatment or after dyeing. More preferably, the raising treatment is conducted after heat-drying the provided aqueous dispersion of elastic polymer, because the elastic polymer is selectively fixed to the vicinity of interface between the raised portion and the artificial leather. The aqueous dispersion of elastic polymer is provided to the surface by a known method such as a dip-nip method, a gravure method and a spray method, with the gravure method being particularly preferred because the elastic polymer is likely to be fixed only to the vicinity of interface between the raised portion and the artificial leather and the elastic polymer is provided discontinuously, to obtain a good hand and surface touch. The amount of the elastic polymer to be provided is selected according to the use and required properties, and preferably, the elastic polymer is provided to the vicinity of interface in an amount of 0.5 to 7% by mass based on the artificial leather. If being 0.5% by mass or more, the microfine fibers in the vicinity of the interface are effectively held by the elastic polymer. If being 7% by mass or less, an appropriate amount of the elastic polymer is provided to the vicinity of the interface, to give a good appearance and surface touch.

After providing the elastic polymer to the surface of the artificial leather, the thickness is regulated to the desired level by a press-heating treatment or a dividing treatment, if necessary. At least one surface of the artificial leather is raised by buffing, etc. to form a raised surface mainly composed of microfine fibers, thereby obtaining a suede-finished artificial leather. The thickness is controlled by a buffing treatment before or after converting the microfine fiber-forming fibers to microfine fibers. The surface is raised preferably after proving the aqueous dispersion of elastic polymer to the surface of the artificial leather, drying and fixing a part of the microfine fibers in the bundles present in the vicinity of the interface, because the excessive elastic polymer which do not take part in fixing the microfine fibers can be easily removed by the raising treatment. A softening treatment such as crumpling and a surface finishing treatment such as reverse seal brushing may be employed. The artificial leather of the present invention has a good hand and appearance because the migration of the elastic polymer is prevented.

By providing a resin layer on the artificial leather, a grain-finished or semi grain-finished artificial leather is obtained. The resin layer may be formed also by press-heating the surface so as to fuse the surface portion of the artificial leather. A known elastic polymer such as polyurethane and acrylic resin is preferably used as the resin to be provided to the surface. The resin layer may be colored by an extremely small amount of dye or a small amount of pigment. If necessary, a woven or knitted fabric is bonded to the artificial leather as a lower layer thereof. Alternatively, the suede-fished artificial leather may be bonded with a lower layer composed of fibers different from those constituting the suede-finished artificial leather.

### EXAMPLES

The present invention is described below in more detail with reference to the examples. However, it should be noted that the scope of the present invention is not limited thereto.

### Example 1

Sea-island fibers (sea component/island component=30/70 by mass, number of islands=64) were composite-spun using a polyethylene terephthalate copolymerized with 10 mol % of isophthalic acid (mp: 234° C.) as the island component and a polyvinyl alcohol copolymer (“Exceval” manufactured by Kuraray Co., Ltd., ethylene units=10 mol %, degree of saponification=98.4 mol %, mp=210° C.) as the sea component. The sea-island fibers were drawn to obtain microfine fiber-forming fibers having a single fiber fineness of 5.5 dtex, an island fiber fineness of 0.026 dtex and a density of 1.27 g/cm³. After crimping, the microfine fiber-forming fibers ware cut into staples with 51 mm length. By carding the staples, a short-fiber web was obtained.

False-twisted polyester yarns (84 dtex/36f) were further twisted by 600 T/m and woven in a fabric density of 82×76 inch to obtain a plain woven fabric having a mass per unit area of 55 g/m².

The web and the plain woven fabric were superposed, needle-punched in a density of 1265 punch/cm² and dried under heating at 205° C. to cause areal shrinking, to obtain a fiber-entangled body having a mass per unit area of 580 g/m², an apparent density of 0.450 g/cm³, and a thickness of 1.2 mm.

An aqueous dispersion of elastic polymer having a concentration of 14% by mass and a density of 1.02 g/cm³ was prepared by adding sodium sulfate decahydrate to an aqueous emulsion of an ether-type polyurethane (“Evafanol AP-12” manufactured by Nicca Chemical Co., Ltd.) and diluting with water such that the sodium sulfate decahydrate/emulsion solid content is 3 parts. The heat-sensitive gelation temperature of the obtained aqueous dispersion of elastic polymer was 60° C.

Using a lip coater (a lip direct type manufactured by Hirano Tecseed Co., Ltd.), the aqueous dispersion of elastic polymer was impregnated into the fiber-entangled body in an amount meeting the ratio of (artificial leather+woven or knitted fabric)/elastic polymer=80/20 (by mass). After the impregnation, the temperature of the surface of the fiber-entangled body was raised to 100° C. within one minute by irradiating infrared rays having a maximum energy wavelength of 2.6 μm for 60 s at 97 V. The water content after the infrared irradiation for 60 s was 30%. By drying under heating for 7.5 min using a hot-air dryer at 155° C., the water was completely evaporated, and simultaneously, the elastic polymer was cured and allowed to fix to the fiber-entangled body. Then the polyvinyl alcohol copolymer was extracted with a hot water of 90° C. to convert the microfine fiber-forming fibers to bundles of microfine fibers, thereby obtaining an artificial leather. The obtained artificial leather was free from wrinkles and elongation and had a good appearance and natural leather-like uniform hand and good properties.

After smoothening the surface of the artificial leather, the surface was gravure-coated with a 20% aqueous emulsion of an ether-type polyurethane (“WLI-612” manufactured by DIC Corporation) at a coating speed of 8 m/min using a 140-mesh roll. The amount of the coated elastic polymer was 3.5% by mass of the artificial leather. Then, the surface was raised by buffing with a #320 paper.

The raised artificial leather was dyed under pressure at 130° C. using “Sumikaron UL” disperse dye manufactured by Sumitomo Chemical Company, Limited (0.24 owf % of Yellow 3RF, 0.34 owf % of Red GF, 0.70 owf % of Blue GF), 2 owf % of “Antifade MC-500” manufactured by Meisei Chemical Works, Ltd. and 1 g/L of “Disper TL” manufactured by Meisei Chemical Works. The fibers on the surface of the dyed product were ordered by buffing with a #400 paper, to obtain a suede-finished artificial leather. The cross section perpendicular to the lengthwise direction of the bundles of microfine fibers in the central portion to the lower layer was observed under an electron microscope. The elastic polymer penetrated into the bundles of fibers in an areal ratio of 3% in average. The penetrated elastic polymer was discontinuous in the lengthwise direction. In the bundles of fibers in the surface layer, the elastic polymer penetrated in an areal ratio of 10%. The elastic polymer was not found in the central portion of the bundles of fibers. The obtained suede-finished artificial leather was free from buckling and wrinkles, and had a good hand with softness and a good appearance with raised fibers having a uniform length. The seat for chair produced from the suede-finished artificial leather little suffered from the pull-out of raised fibers.

### Example 2

The procedure of Example 1 was repeated except for irradiating infrared rays for 90 s at 97 V so as to reduce the water content after infrared irradiation for 90 s to 20%. The elastic polymer penetrated into the bundles of microfine fibers in an areal ratio of 2%. The obtained suede-finished artificial leather was free from buckling and wrinkles, and had a good hand with softness and a good appearance with raised fibers having a uniform length. The seat for chair produced from the suede-finished artificial leather little suffered from the pull-out of raised fibers.

### Example 3

The procedure of Example 1 was repeated except for irradiating infrared rays for 60 s at 80 V so as to raise the surface temperature of the fiber-entangled body to 90° C. within one minute. The elastic polymer penetrated into the bundles of microfine fibers in an areal ratio of 3.5%. The artificial leather thus obtained was free from buckling and wrinkles and had a good hand with softness. The fibers therein were firmly held. The suede-finished artificial leather produced from the artificial leather had a good appearance with raised fibers having a uniform length. The seat for chair produced from the suede-finished artificial leather little suffered from the pull-out of raised fibers.

### Example 4

The procedure of Example 1 was repeated except for using nylon as the island component of the microfine fiber-forming fibers. The elastic polymer penetrated into the bundles of microfine fibers in an areal ratio of 3%. The suede-finished artificial leather thus obtained was free from buckling and wrinkles, and had a good hand with softness and a good appearance with raised fibers having a uniform length. The blouson produced from the suede-finished artificial leather little suffered from the pull-out of raised fibers after wear trial.

### Comparative Example 1

The procedure of Example 1 was repeated except for using polyethylene as the sea component of the microfine fiber-forming fibers, conducting the areal shrinking by a hot-water shrinking, and converting the microfine fiber-forming fibers to microfine fibers by extracting the polyethylene with toluene. The cross section perpendicular to the lengthwise direction of the bundles of microfine fibers was observed under an electron microscope. An empty space was formed between the elastic polymer and the periphery of the bundles of fibers, and the elastic polymer did not penetrate into the bundles of fibers. Therefore, the bundles of microfine fibers were not sufficiently held by the elastic polymer and long raised fibers pulled-out were markedly found on the surface of the obtained suede-finished artificial leather, to result in a poor appearance having raised fibers with uneven length. The seat for chair produced from the suede-finished artificial leather significantly suffered from the pull-out of raised fibers.

### Comparative Example 2

The procedure of Example 1 was repeated except for converting the microfine fiber-forming fibers to microfine fibers by extraction with a hot water at 90° C. and then impregnating the aqueous dispersion of elastic polymer into the fiber-entangled body. The elastic polymer penetrated into the bundles of microfine fibers in an areal ratio of 50%. Although the fibers were firmly held, the obtained suede-finished artificial leather had a hard and poor hand.

### Comparative Example 3

The procedure of Example 1 was repeated except for irradiating infrared rays for 60 s at 30 V. The water content after the infrared irradiation was 60%. The elastic polymer migrated toward the surface layer and the fibers in the surface layer of the obtained suede-finished artificial leather were covered with the resin, to markedly deteriorate the raised feeling. In addition, the elastic polymer penetrated into the bundles of microfine fibers around the surface layer of the suede-finished artificial leather in an areal ratio of 35%. Therefore, the suede-finished artificial leather suffered from buckling and has a poor hard hand.

### Comparative Example 4

Into the fiber-entangled body obtained in Example 1, the aqueous dispersion of elastic polymer was impregnated in an amount meeting the ratio of (artificial leather+woven or knitted fabric)/elastic polymer=80/10 (by mass). After the impregnation, the fiber-entangled body was dried under heating for 10 min using a hot air dryer, to completely evaporate the water. Simultaneously, the elastic polymer was cured and allowed to fix to the fiber-entangled body. Thereafter, the microfine fiber-forming fibers were converted to microfine fibers by extracting the polyvinyl alcohol copolymer with a hot water at 90° C. Then, the aqueous dispersion of elastic polymer was again impregnated in an amount meeting the ratio of (artificial leather+woven or knitted fabric)/elastic polymer=80/10 (by mass). After the impregnation, the fibrous body was dried under heating for 10 min by a hot air dryer to completely evaporate the water. Simultaneously, the elastic polymer was cured and allowed to fix to the fiber-entangled body. Thereafter, by following the procedure of Example 1, an artificial leather and a suede-finished artificial leather were obtained. The elastic polymer penetrated into the bundles of microfine fibers in an areal ratio of 40% or more and reached the center thereof. In addition, around the surface and back surface thereof, the elastic polymer migrated was densified. Therefore, the obtained suede-finished artificial leather has a poor hard hand, although the fibers were firmly held.

### INDUSTRIAL APPLICABILITY

According to the present invention, an artificial leather with a good hand in which microfine fibers are firmly held is obtained. The suede-finished artificial leather produced from the artificial leather has a uniform raised appearance because the pull-out of the raised fibers on its surface is prevented without deteriorating the hand. The suede-finished artificial leather of the present invention is applicable to the production of seat of chair, clothes such as blouson and hand gloves, accessory of dress, shoes, bags, etc.

What is claimed is:

1. An artificial leather which comprises an entangled body made of bundles of microfine fibers and an elastic polymer impregnated into the entangled body, wherein a part of the elastic polymer penetrates into the bundles of microfine fibers and a degree of penetration of the elastic polymer is from 1 to 30% by area when measured on a cross section which is taken along a direction perpendicular to a lengthwise direction of the bundles of microfine fibers.

2. The artificial leather according to claim 1, wherein the elastic polymer substantially penetrates into the fiber-entangled body discontinuously.

3. A suede-finished artificial leather which is produced from the artificial leather as defined in claim 1 or 2.

4. The suede-finished artificial leather according to claim 3, wherein a part of the microfine fibers in bundles of microfine fibers in the vicinity of an interface between a raised portion and the artificial leather is fixed by the elastic polymer.

5. A method of producing an artificial leather, which comprises:
(1) a step of impregnating an aqueous dispersion of elastic polymer into a fiber-entangled body which is formed from composite fibers comprising a water-soluble polymer component and a sparingly water-soluble polymer component;
(2) a step of raising a temperature of a surface of the fiber-entangled body impregnated with the aqueous dispersion of elastic polymer by an infrared irradiation to a temperature which is 10° C. or more higher than a gelation temperature of the aqueous dispersion of elastic polymer;
(3) a step of reducing a water content of the fiber-entangled body to 50% by mass or less while keeping the surface of the fiber-entangled body at a temperature which is 10° C. or more higher than the gelation temperature of the aqueous dispersion of elastic polymer;
(4) a step of removing water remaining in the fiber-entangled body by drying, thereby fixing the elastic polymer to the fiber-entangled body; and
(5) a step of converting the composite fibers to bundles of microfine fibers by extracting the water-soluble polymer component with a hot water from the composite fibers in the fiber-entangled body having the elastic polymer fixed.

6. The method according to claim 5, wherein a maximum energy wavelength of infrared rays is 2 to 6 μm.

7. A method of producing a suede-finished artificial leather, which comprises a step of providing an aqueous dispersion of elastic polymer to a surface of the artificial leather produced by the method according to claim 1 or 2;
a step of drying to fix a part of microfine fibers in bundles of microfine fibers which are exposed to a surface of the artificial leather by the elastic polymer; and
a step of raising the surface.
